(19) United States
(12) Patent Application Publication
(10) Pub. No.: US 2024/0429528 A1
(43) Pub. Date: Dec. 26, 2024

(54) BATTERY PACK HAVING VIBRATION RESISTANT STRUCTURAL FRAME ASSEMBLY FOR ELECTRIFIED VEHICLE

(71) Applicant: FCA US LLC, Auburn Hills, MI (US)

(72) Inventors: Juanxia Dong, Shanghai (CN); Zi Ye Wang, Shanghai (CN); Xingjia Li, Shanghai (CN); Deming Leo Luo, Shanghai (CN); Xiu Min Song, Shanghai (CN)

(21) Appl. No.: 18/340,452

(22) Filed: Jun. 23, 2023

(51) Int. Cl. H01M 50/249; B60K 1/04; H01M 10/613; H01M 10/625; H01M 10/6554; H01M 10/6556

(52) U.S. Cl. CPC H01M 50/249; B60K 1/04; H01M 10/613; H01M 10/625; H01M 10/6554; H01M 10/6556; B60K 2001/0438; H01M 2220/20

(57) ABSTRACT

A battery pack assembly for an electrified vehicle includes a main body assembly comprising a structural frame support assembly including a floor module support frame and a cooling plate. The floor module support frame includes a central body, a first protrusion support and a second protrusion support. The central body has an upper surface that extends along a central body plane. The first protrusion support can be configured along a first edge and have an upper surface that extends along a first support plane that is offset from the central body plane. The second protrusion support can be configured along a second end and have an upper surface that extends along a second support plane that is offset from the central body plane. The first and second protrusion supports can inhibit relative movement between the cooling plate and floor module support frame.

### FIELD

The present application generally relates to electrified vehicles and, more particularly, to a battery pack incorporating a vibration resistant structural frame assembly.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. In some instances, vehicle vibration and/or impact loads experienced during driving can cause deformation of battery pack components including the cooling plate and the battery pack assembly as a whole. In particular, critical components including the cooling plate and surrounding module support frame members can be arranged with gaps therebetween. Gaps between adjacent components can encourage vibration amplitudes to be increased that can cause undesirable material damage such as cracking in the cooling plates and/or the module support frame members. Accordingly, while such conventional battery pack assemblies do work well for their intended purpose, there exists an opportunity for improvement in the relevant art.

### SUMMARY

According to one example aspect of the invention, a battery pack assembly for an electrified vehicle includes a main body assembly comprising a structural frame support assembly. The structural frame support assembly includes a floor module support frame and a cooling plate. The floor module support frame supports an upper battery housing. The floor module support frame includes a central body, a first protrusion support and a second protrusion support. The central body has an upper surface that extends along a central body plane. The first protrusion support can be configured along a first edge and have an upper surface that extends along a first support plane. The first support plane can be offset from the central body plane. The second protrusion support can be configured along a second ends and have an upper surface that extends along a second support plane. The second support plane can be offset from the central body plane. The cooling plate can be supported by the floor module support frame and have a first lateral side that engages and is structurally supported by the upper surface of the first protrusion. A second lateral side of the cooling plate can be engaged to and structurally supported by the upper surface of the second protrusion support. The first and second protrusion supports can inhibit relative movement between the cooling plate and floor module support frame.

In some implementations, the first and second support planes are co-planar. The floor module support frame can include a plurality of first apertures defined through the first protrusion support and a second plurality of apertures defined through the second protrusion support. The cooling plate can define cooling plate apertures that align with the plurality of first and second apertures for receiving fasteners. The fasteners can threadably mate with receiving structure provided to the support frame assembly.

According to another example aspect of the invention, the structural frame support assembly can further comprise a front beam, a rear beam, a first side beam and a second side beam. A plurality of first floor cooling plates can occupy a first layer in the main body assembly.

In some implementations, the structural frame support assembly can include a first floor module support frame wherein the floor module support frame comprises a second floor module support frame that is arranged generally parallel and offset relative to the first floor module support frame.

In other examples, a holding pad is disposed between the floor module support frame and the cooling plate at the central body. The holding pad can be formed of a vibration resistant material. The holding pad cam be formed of expanded polypropylene.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is front perspective view of a main body assembly of the battery pack assembly of the battery system of FIG. 1 according to the principles of the present application;

FIG. 3 is a top view of the main body assembly of FIG. 2 according to the principles of the present application;

FIG. 4 is a sectional view of the main body assembly taken along lines 4-4 of FIG. 3 according to the principles of the present application;

FIG. 5 is a detail view of the main body assembly taken around area 5 of FIG. 4 according to principles of the present application;

FIG. 6 is a detail view of the main body assembly taken around area 6 of FIG. 4 according to principles of the present application;

FIG. 7 is a perspective view of the second floor module support frame assembly according to principles of the present application;

FIG. 8 is a sectional view of the first support frame assembly of the second floor module support frame assembly taken along lines 8-8 of FIG. 7; and

FIG. 9 is a sectional view of the first support frame assembly of the second floor module support frame assembly taken along lines 9-9 of FIG. 7.

### DESCRIPTION

As discussed above, a high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. In some battery pack assemblies, there are multiple cooling plates arranged in multiple layers withing the battery pack assembly. In some instances, vehicle vibration and/or impact loads experienced during driving of the vehicle can cause undesirable relative movements of components in a battery pack such as frame members and cooling plates. Over the life of a vehicle, such repeated vibrations experienced by the battery packs can lead to deformation of battery pack components including the cooling plate. Over time, such vibrations can ultimately lead to failure of one or more components of the battery pack such as a cracking or rupture of one of the cooling plates. Further, the surrounding frame members can also experience such cracking due to repeated vibrations.

Accordingly, the structural frame support configuration of the battery pack of the instant disclosure incorporates a second floor module support frame assembly having strategically located protrusions that take gaps that may otherwise exist between the cooling plate and support frame. The protrusions can inhibit relative movements between adjacent components. In particular, the present disclosure provides an integrated design that ensures the transmission of vibration or impact loads in a more uniform manner mitigating any potential damage to the components of the battery pack including the cooling plates and surrounding frame assembly during the life of the vehicle. As a result, the overall anti-impact and vibration absorption ability of the battery pack as a whole is effectively enhanced.

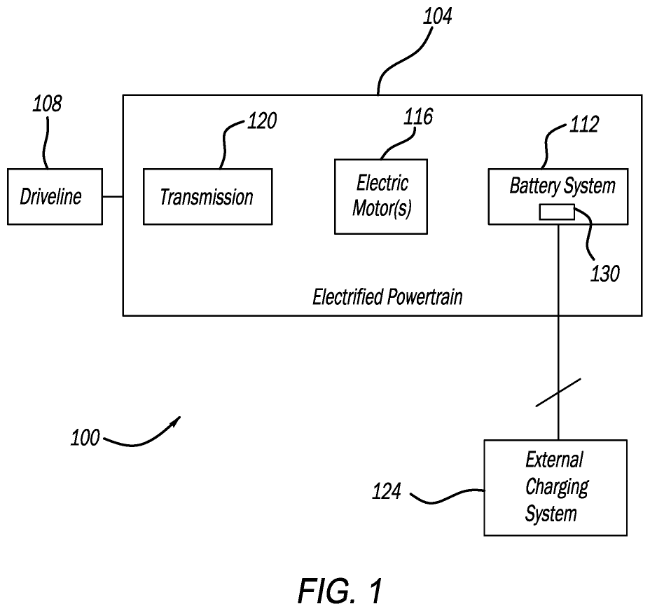

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

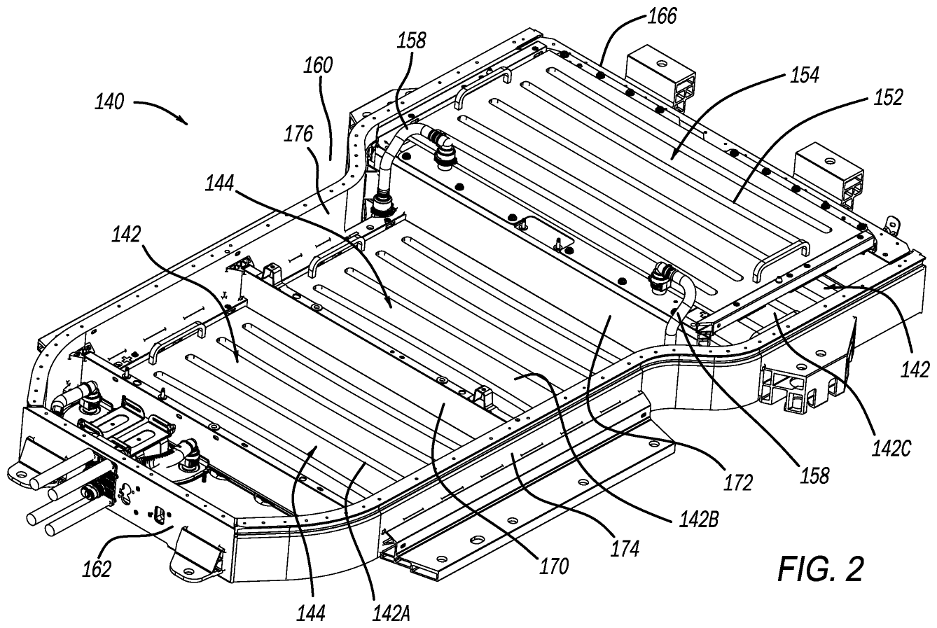

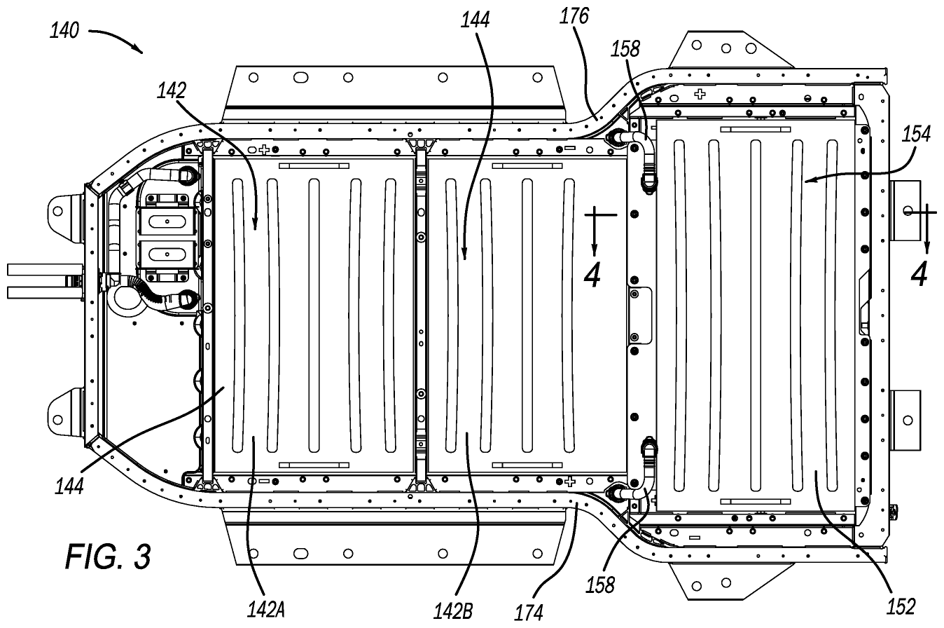

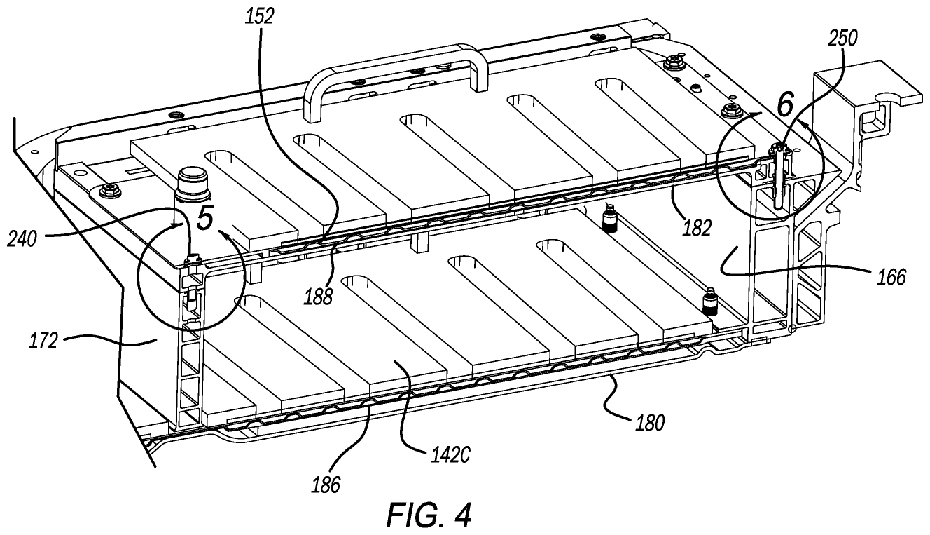

Referring now to FIGS. 2-9, additional features of the instant battery pack assembly 130 will be described. In examples, the battery pack assembly 130 can generally include a lower battery housing 132 and an upper battery housing 134. The battery pack assembly 130 according to one example of the present disclosure includes a main body assembly 140. The main body assembly 140 generally represents the battery pack assembly 130 with the batteries removed for illustration purposes. In general however, the battery pack assembly 130 can include a lower battery housing 132 and an upper battery housing 134. Batteries, not specifically shown, are generally housed in the battery pack assembly 130 under a top cover (not shown).

The main body assembly 140 further houses a plurality of first floor cooling plates collectively identified at 142 and individually identified at references 142A, 142B and 142C. The first floor cooling plates 142 occupy a first layer 144 in the main body assembly 140. In addition, the main body assembly 140 houses a second floor cooling plate 152 that occupies a second layer 154 within the main body assembly 140. In examples, the first and second layers 144 and 154 of cooling plates 142 and 152 are parallel and offset. The cooling plates 142 and 152 are configured to cool components of the battery pack assembly 130 by routing cooling fluid through various internal passages withing the cooling plates 142 and 152. Cooling fluid can be routed between the various cooling plates 142 and 152 by fluid tubes 158.

The main body assembly 140 of the battery pack assembly 130 according to some implementations of the present application generally includes a structural frame support assembly 160. The structural support frame assembly 160 can include a front beam 162, a rear beam 166, a first intermediate beam 170, a second intermediate beam 172, a first side beam 174 and a second side beam 176. The structural support frame assembly 160 can further include a first floor module support frame or bottom plate 180 and a second floor module support frame 182. In examples, the first floor module support frame 180 can support the lower battery housing 132. Further, the first floor module support frame 180 can support the first floor cooling plates 142.

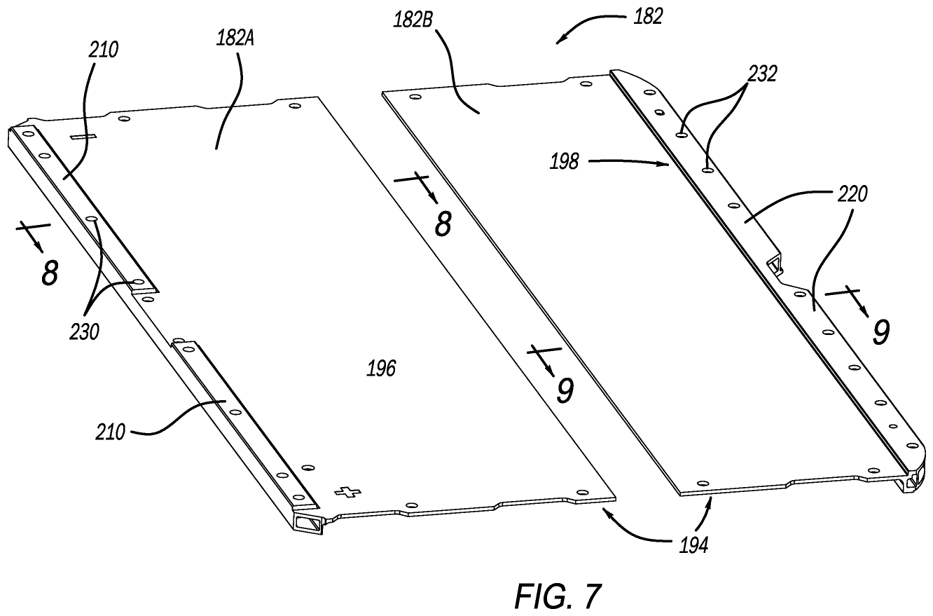

In examples, the second floor module support frame 182 can be arranged generally parallel and offset relative to the first floor module support frame 180. In one implementation, the second floor module support frame 182 can collectively comprise a first and second module support frames 182A and 182B (FIG. 7).

The second floor module support frame 182 can support the upper battery housing 134. Further, the second floor module support frame 182 can support the second floor cooling plate 152. A first floor holding pad 186 is disposed between the first floor module support frame 180 and the cooling plate 142C. A second floor holding pad 188 is disposed between the second floor module support frame 182 and the cooling plate 152. The first and second floor holding pads 186 and 188 can be formed of vibration resistant material such as, but not limited to, expanded polypropylene such as EPP90.

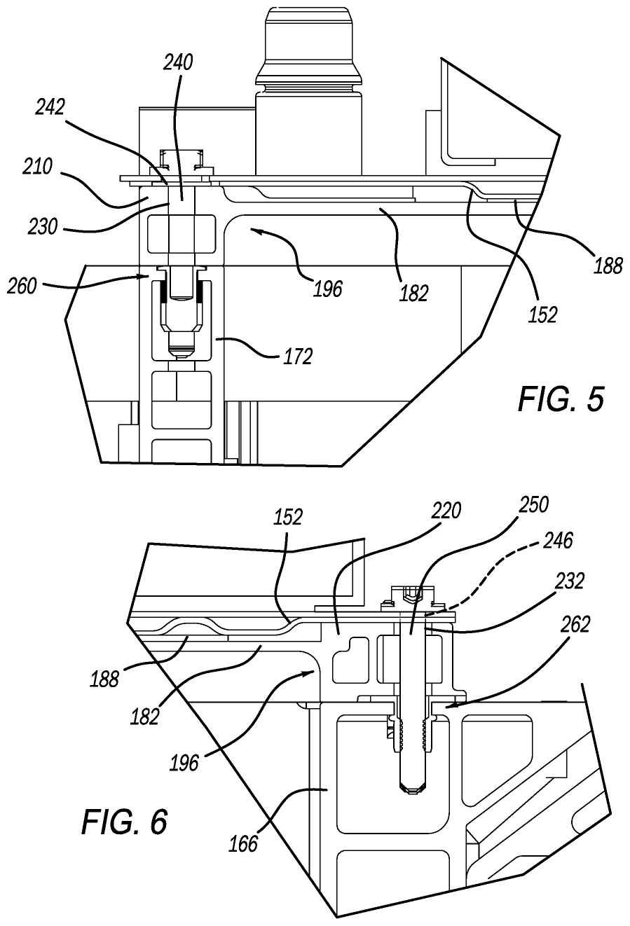

With particular reference now to FIGS. 5-9, the second floor module support frame 182 will be described in more detail. The second floor module support frame 182 includes a central body 194 including a first edge 196 and a second edge 198. The central body 194 can have a first protrusion support 210 configured along the first edge 196 and a second protrusion support 220 configured along the second edge 198. A plurality of first apertures 230 are defined through the second floor module support frame 182 along the first edge 196. A plurality of second apertures 232 are defined through the second floor module support frame 182 along the second edge 198.

A plurality of first fasteners 240 (FIG. 5) can be located through apertures 242 defined in the cooling plate 152 and the respective plurality of first apertures 230 in the second floor module support frame 182. A plurality of second fasteners 250 (FIG. 6) can be located through apertures 246 defined in the cooling plate 152 and the respective plurality of second apertures 232 in the second floor module support frame 182. The plurality of first and second fasteners 240 and 250 threadably mate with receiving structure 260 and 262 provided on the second intermediate beam 172 and the rear beam 166, respectively, of the structural support frame assembly 160.

The resulting structure of the cooling plate 152, the holding pad 188 and the second floor module support frame 182 resists relative movement between the cooling plate 152, the holding pad 188 and the second floor module support frame 182 at the first and second edges 196 and 198 thereby inhibiting transmitted vibrations experienced at the cooling plate 152 and within the battery pack assembly 130 as a whole. Explained further, the first and second protrusion supports 210 and 220 engage and thereby structurally support respective first and second lateral sides 270 and 272 of the cooling plate 152 to inhibits relative movement between the cooling plate 152 and the second floor module support frame 182. In other words, gaps between the cooling plate and the second floor module support frame 182 near the fasteners 240 and 250 are effectively eliminated. Because vibrations and impact forces are not as easily transmitted between adjacent components (e.g., the second floor module support frame 182, the holding pad 188 and the cooling plate 152), the cooling plate 152 and the second floor support module frame 182 are both less susceptible to damage such as cracking over the life of the electrified vehicle 100.

As the cooling plate 152, holding pad 188 and second floor module support frame 182 are separate components, vibration amplitudes experienced during normal driving of the electrified vehicle 100 tend to amplify without inhibiting relative movements between these components. With the first and second protrusion supports 210 and 220 engaging and thereby structurally supporting respective lateral sides 270 and 272 of the cooling plate 152, vibrations are not as easily transmitted between the second floor module support frame 182 and the cooling plate 152. In this regard, the cooling plate 152 and the second floor module support frame 182 both experience minimal disruption and therefore deformations that could ultimately lead to damage during the life of the battery pack assembly 130.

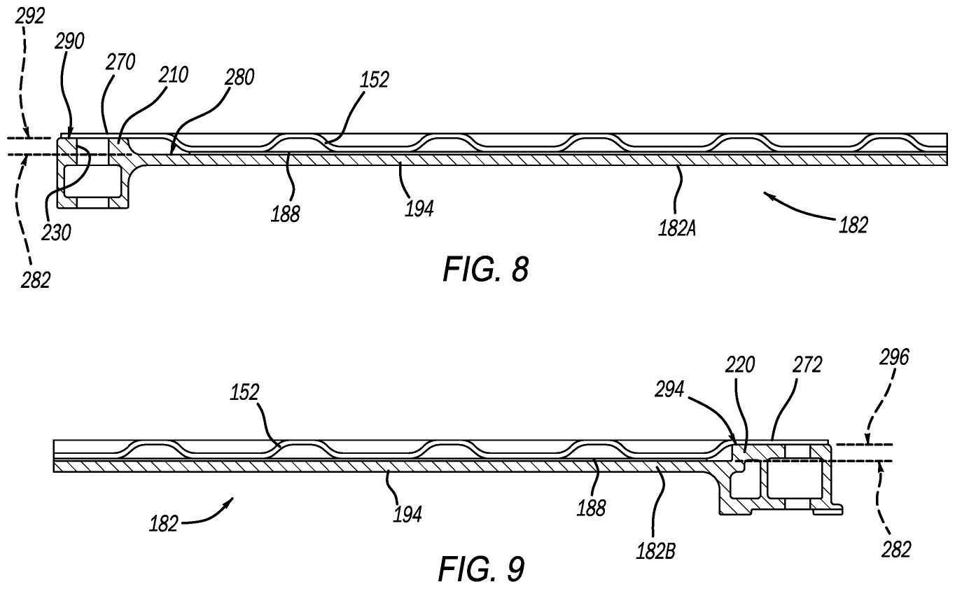

With specific reference now to FIGS. 8 and 9, additional aspects of the first and second protrusion supports 210 and 220 will be described. The central body 194 has an upper surface 280 that extends along a central body plane 282. The first protrusion support 210 has an upper surface 290 that extends along a first support plane 292. According to the present disclosure, the first support plane 292 is parallel and offset relative to the central body plane 282. In advantages, the offset raises the upper surface 290 such that it aligns for supporting the lateral side 270 of the cooling plate 152. The second protrusion support 220 has an upper surface 294 that extends along a second support plane 296. According to the present disclosure, the second support plane 296 is parallel and offset relative to the central body plane 282. In examples, the first and second support planes 292 and 296 can be co-planar. In advantages, the offset raises the upper surface 294 such that it aligns for supporting the lateral side 272 of the cooling plate 152.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery pack assembly for an electrified vehicle, the battery pack assembly comprising:
a main body assembly comprising a structural frame support assembly, the structural frame support assembly comprising:
a floor module support frame that supports an upper battery housing, the floor module support frame having:
a central body having an upper surface that extends along a central body plane;
a first protrusion support configured along a first edge and having an upper surface that extends along a first support plane, the first support plane offset from the central body plane; and
a second protrusion support configured along a second edge and having an upper surface that extends along a second support plane, the second support plane offset from the central body plane; and
a cooling plate supported by the floor module support frame, the cooling plate having a first lateral side that engages and is structurally supported by the upper surface of the first protrusion, and a second lateral side that engages and is structurally supported by the upper surface of the second protrusion support, the first and second protrusion supports inhibiting relative movement between the cooling plate and floor module support frame.

2. The battery pack assembly of claim 1, wherein the first and second support planes are co-planar.

3. The battery pack assembly of claim 1, wherein the floor module support frame includes a plurality of first apertures defined through the first protrusion support and a second plurality of apertures defined through the second protrusion support.

4. The battery pack assembly of claim 3, wherein the cooling plate defines cooling plate apertures that align with the plurality of first and second apertures for receiving fasteners.

5. The battery pack assembly of claim 4, wherein the fasteners threadably mate with receiving structure provided on the support frame assembly.

6. The battery pack assembly of claim 1, wherein the structural frame support assembly further comprises a front beam, a rear beam, a first side beam and a second side beam.

7. The battery pack assembly of claim 1, further comprising a plurality of first floor cooling plates that occupy a first layer in the main body assembly.

8. The battery pack assembly of claim 1, further comprising a first floor module support frame wherein the floor module support frame comprises a second floor module support frame that is arranged generally parallel and offset relative to the first floor module support frame.

9. The battery pack assembly of claim 1, further comprising a holding pad disposed between the floor module support frame and the cooling plate at the central body.

10. The battery pack assembly of claim 9, wherein the holding pad is formed of a vibration resistant material.

11. The battery pack assembly of claim 10, wherein the holding pad is formed of expanded polypropylene.

12. A battery pack assembly for an electrified vehicle, the battery pack assembly comprising:
a main body assembly comprising a structural frame support assembly, the structural frame support assembly comprising:
an upper floor module support frame that supports an upper battery housing, the upper floor module support frame having:
a central body having an upper surface that extends along a central body plane;
a first protrusion support configured along a first edge and having an upper surface that extends along a first support plane, the first support plane offset from the central body plane; and
a second protrusion support configured along a second edge and having an upper surface that extends along a second support plane, the second support plane offset from the central body plane;
an upper cooling plate supported by the upper floor module support frame, the upper cooling plate having a first lateral side that engages and is structurally supported by the upper surface of the first protrusion, and a second lateral side that engages and is structurally supported by the upper surface of the second protrusion support, the first and second protrusion supports inhibiting relative movement between the upper cooling plate and upper floor module support frame;
a lower floor module support frame that supports a lower battery housing; and
a lower cooling plate supported by the lower floor module support frame.

13. The battery pack assembly of claim 12, wherein the first and second support planes are co-planar.

14. The battery pack assembly of claim 12, wherein the upper floor module support frame includes a plurality of first apertures defined through the first protrusion support and a second plurality of apertures defined through the second protrusion support.

15. The battery pack assembly of claim 14, wherein the upper cooling plate defines cooling plate apertures that align with the plurality of first and second apertures for receiving fasteners.

16. The battery pack assembly of claim 15, wherein the fasteners threadably mate with receiving structure provided on the support frame assembly.

17. The battery pack assembly of claim 12, wherein the structural frame support assembly further comprises a front beam, a rear beam, a first side beam and a second side beam.
